(19) United States
(12) Patent Application Publication
(10) Pub. No.: US 2009/0008821 A1
(43) Pub. Date: Jan. 8, 2009

(54) Composition for Insulating Concrete, a Building Element for Producing a Lost Formwork Produced with a Said Concrete, a Lost Formwork Made from Said Elements and a Thus Produces Supporting Wall

(76) Inventor: Henri Clervil, La Montagne ILE DE LA REUNION (FR)

Correspondence Address: EGBERT LAW OFFICES, 412 MAIN STREET, 7TH FLOOR, HOUSTON, TX, 77002, US

(21) Appl. No.: 11/910,905

(22) PCT Filed: Jan. 31, 2006
(86) PCT No.: PCT/EP2006/050548

§ 371 Date: Apr. 18, 2008

(30) Foreign Application Priority Data
Feb. 2, 2005 (FR) 0501048

(51) Int. Cl. B32B 37/14; C04B 14/02; C04B 28/08; C04B 24/26

(52) U.S. Cl. 264/261; 106/817; 106/790; 524/2

(57) ABSTRACT

The invention relates to a insulating concrete composition for producing, mainly, moulded building elements. The invention is a composition having a weight proportion of slag in the form of gravel and sand ranging from 40 to 80%, and a cement weight proportion ranging from 20 to 30%. The composition is used with water whose weight proportion ranges from 10 to 20% for obtaining a concrete. The invention also relates to an insulating building element which is made from the concrete and is used for producing a lost workform filled with concrete in order to build a carrying wall. After drying, the element forms an insulating coating for the carrying wall.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

This invention concerns a concrete composition, aimed more particularly for producing porous elements with high heat and sound insulating capacity.

This invention also concerns a building element more particularly aimed for producing facade siding.

2. Description of Related Art Including Information Disclosed Under 37 CFR 1.97 and 37 CFR 1.98.

In this document, it is understood that “slag” refers to approx. 1.6 Kg/dm³ low-density vesicular lava fragments, being unevenly porous and bristling with barbs and spikes.

The term “fines” is understood to refer to elements in the form of less than 1 mm particles.

The slag of the predefined type is currently used for landscaping (black or red), private or semi-collective sewage disposal as a filter because of its purifying capacity, crop substrate constitution, and forest path metaling which is a yearly operation that consists of repairing damaged forest paths and tracks. From a technical point of view, slag does not offer the characteristics suitable for road metaling because it is too friable and is easily crushed when driven over by vehicles and becomes sensitive to water.

Slag seems to have never been used in the fabrication of building materials because of its high fines content that make its use impossible in a mixture for conventional hydraulic concrete based on the requirements for building structural members. Thus, for a person having ordinary skill in the art, the use of slag is deemed improper and not recommended for construction.

However, some documents from the state of the art mention the possible use of a limited quantity of lava for making a porous concrete for the production of supporting walls. Thus, EP 1 063 364 is a known patent application regarding an insulating wall comprising an inside sidewall and outside sidewall placed at a distance from each other and defining a space designed to receive an insulating material making up a non supporting mass. The bearing structure of the wall consists of two sidewalls, made of concrete comprising a proportion of porous material in the form of lava to trap air and confer to the achieved product a heat insulation capacity.

However, the heat insulation capacity of the bearing sidewalls cannot be increased without jeopardizing their mechanical strength. However, an increase of the wall insulating capacity is possible by inserting into the space between the sidewalls a suitable filling material.

### BRIEF SUMMARY OF THE INVENTION

The purpose of this invention is to propose a new composition for insulating concrete for producing cast building elements with high heat and sound insulation properties.

To that effect, the new composition for concrete under the invention is primarily characterized in that it contains a part by weight of slag in the form of gravel and sand ranging from 40 to 80%, and a part by weight of cement ranging from 20 to 30%, said composition for the formation of concrete being designed to be added a part by weight of water ranging from 10 to 20%.

This composition gives especially high sound and heat insulation properties to the concrete after drying because of an especially high degree of porosity with over 32.5% of void. The permeability tests made by a materials study and research center show that there is continuity between the voids over the whole thickness of concrete.

According to another characteristic of the invention, the composition for concrete contains a part by weight of slag in the form of gravel and slag ranging from 53 to 72%, and a part by weight of cement ranging from 20 to 22%, said composition for the formation of concrete being designed to be added a part by weight of water ranging from 12 to 18%.

For such a composition, according to another characteristic of the invention, the part by weight of slag gravel and slag sand is distributed as follows:
2-6 mm grain size gravel ranging from 45 to 60%; and
less than 2 mm grain size sand ranging from 8 to 12%.

Such composition for concrete shall be designed for producing any building materials or alike, such as blocks, in the field of heat and sound protection and insulation of walls and floors, using block fillers or in relation to large size elements, or for any other use in the field of permeability, filtering, various protections in the form of lightened concrete and substrates of any kind. With such concrete composition, it will be possible to make porous containers capable of letting water through and retaining the moisture.

According to another characteristic of the invention, the composition for concrete contains a part by weight of slag in the form of gravel and sand ranging from 55 to 65%, and a part by weight of cement ranging from 20 to 25%, said composition for the formation of concrete being designed to be added a part by weight of water ranging from 15 to 18%.

With such a composition, according to another characteristic of the invention, the part by weight of slag gravel and sand slag sand is distributed as follows:
2-6 mm grain size gravel ranging from 35 to 40%; and
less than 2 mm grain size sand ranging from 20 to 25%.

Such composition shall be mainly used for producing any building materials or alike, any other use for the fabrication of various parts or elements made of slag concrete (bricks, paving stones, slabs, blocks, formworks for posts, arches, cornices, fake stones, blocks to be sculpted) and any other art objects or decoration elements, through molding.

The concrete according to this composition can be sanded, which gives it a very silky surface condition, like that of a natural stone.

For either composition, the part by weight of slag fines in the slag sand in relation to the part by weight of sand shall range from 18% to 20%.

The fines play an especially important role by allowing for good cohesion between the sand and gravel grains and particles. The fines form together with the cement a paste making it possible to coat the sand and gravel grains and particles that become glued together through contact.

The concrete under either embodiment can be added into by any suitable water-reducing plasticizers/admixtures to improve the constant water content during placement. A suitable part by volume shall range from 0.2 to 0.4 liter of admixture per m³ of concrete.

Based on the air temperature, a known setting retarder or accelerator can be added to the concrete.

The concrete under the invention can be added into by reinforcing elements to improve the mechanical properties. These reinforcing elements can for example come in the form of fiber, for example, 6-12 mm polypropylene fiber.

The concrete can also be added into by any suitable coloring agents.

The composition can also be added into by rubber fragments or rubber balls, for example, in a part by weight ranging from 15 to 35% for a part by weight of gravel ranging from 30 to 60% and a part by weight of cement ranging from 20 to 30%. Such composition gives increased sound insulation capabilities to the produced building element.

Preferably, the sizing of the fragments or balls shall range from 1 to 6 mm.

The slag concrete proposed by the invention does not show any hydraulic contraction contrary to a conventional concrete.

Another purpose of this invention is to propose a building element with high heat insulation properties, capable of making up first a sidewall formwork element. Then, after pouring and curing of the concrete, a facing or siding element is given to the wall produced through concrete pouring between said elements a high heat and sound insulation capacity.

To that effect, the building element under the invention is primarily characterized in that it is made from a hydraulic mixture with a part by weight of slag in the form of gravel and sand ranging from 40 to 80%, a part by weight of cement ranging from 20 to 30% and a part by weight of water ranging from 1 to 20%.

Because of the chosen proportions, the building element has a high porosity degree due to which a large amount of air becomes trapped within its mass. However, the mechanical properties of the element are not sufficient to withstand significant loads, but sufficient to make up a formwork element, as confirmed by the calculations.

The building element produced can be divided by being sawed into smaller size elements. It is to be noted that sawing gives to these elements the appearance of natural stone.

This invention concerns also a lost formwork made of at least two building elements under the invention, held vertically parallel to each other and apart from each other using cross braces.

This invention concerns also a wall produced through the pouring of load-bearing concrete in a lost formwork made out of the building elements under the invention.

### BRIEF DESCRIPTION OF THE SEVERAL VIEWS OF THE DRAWINGS

Other advantages and characteristics of the invention will become apparent when reading the description of a preferred embodiment given as a non-limiting example while referring to the attached drawings.

FIG. 1 is a schematic view of the top of a building element according to a first embodiment.

FIG. 2 is a schematic view of the top of a building element according to a second embodiment.

FIG. 3 is a perspective view of a lost formwork according to the invention.

FIG. 4 is a sectional view of a lost formwork according to the invention with bracing according to a first embodiment.

FIG. 5 is a partial sectional view of a lost formwork according to the invention with bracing according to a second embodiment.

FIG. 6 is a schematic view of a means of bracing according to the second embodiment.

FIG. 7 is a side view of a means of bracing according to the second embodiment.

FIG. 8 is a cross section view of an alternative means of bracing according to the second embodiment.

FIG. 9 is a front elevation view of a means of bracing according to a third embodiment.

FIG. 10 is a top plan view of the means of bracing according to FIG. 9 in place on a formwork.

FIG. 11 is a front elevation view of an alternative embodiment of the means of bracing according to the third embodiment.

FIG. 12 is a sectional view of a produced wall.

FIG. 13 is a sectional view of a building element equipped with a protection element.

FIG. 14 is a sectional view of the device for fastening a building element under the invention to a metal frame.

FIG. 15 is a sectional view of the device for fastening a building element under the invention to a wood frame.

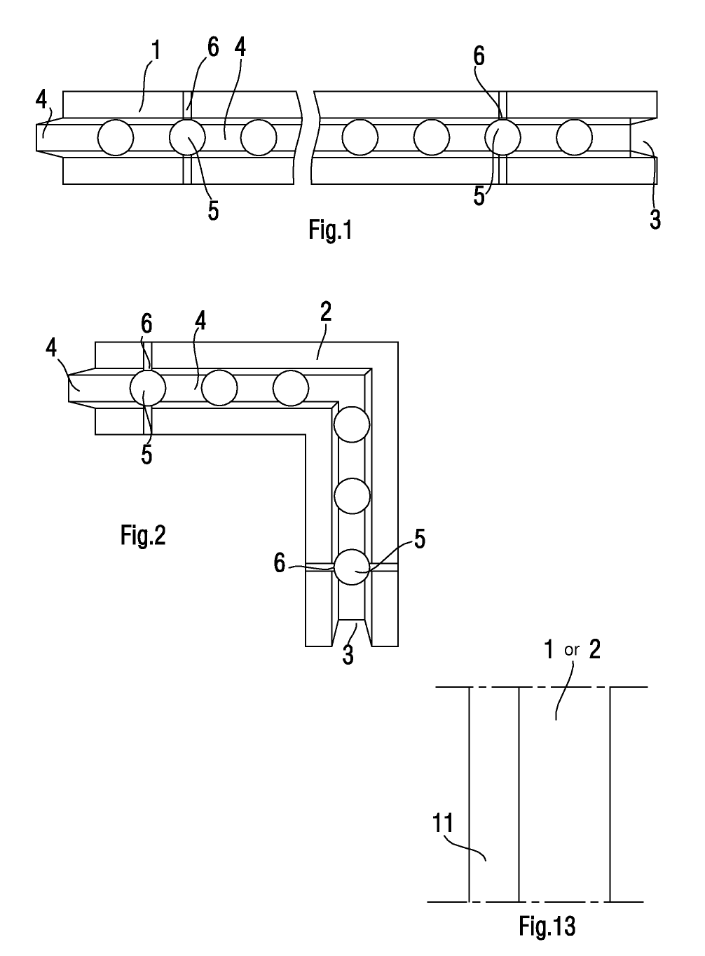

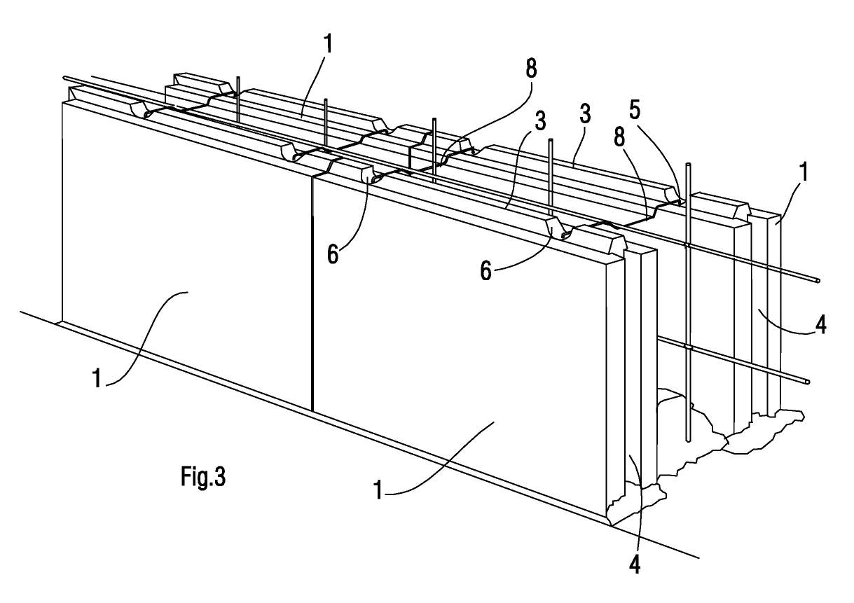

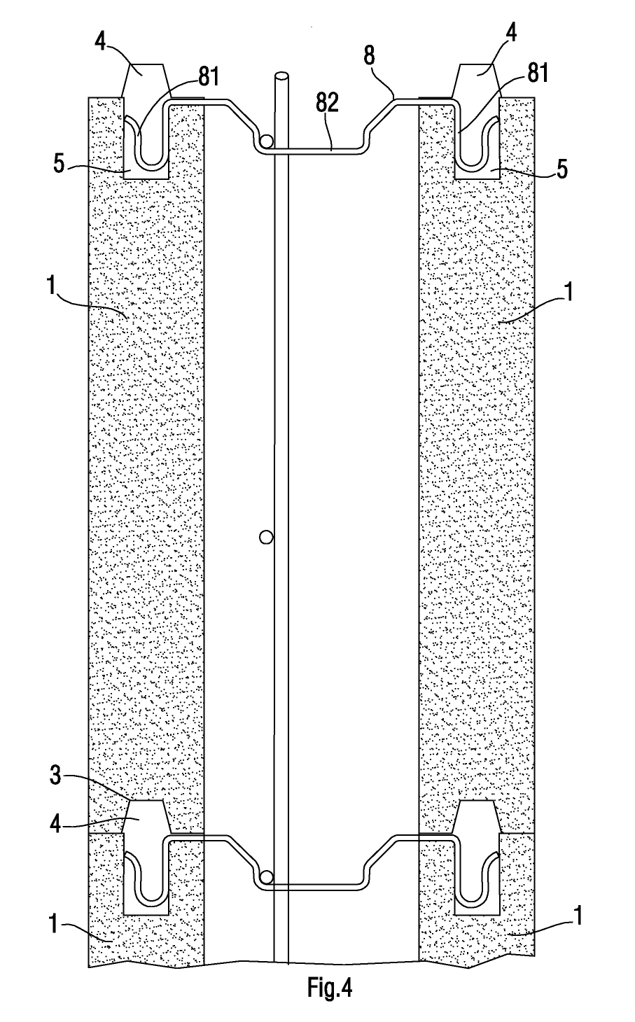

### DETAILED DESCRIPTION OF THE INVENTION

The composition for concrete as previously described is especially for producing concrete by adding water to produce porous building elements with a high insulating capacity.

As shown, the building element 1, 2 under the invention, for producing in particular lost formworks and facing elements, consists of at least one sidewall that can have a rectangular parallelepiped shape and is made from an hydraulic mixture with a part by weight of slag in the form of gravel and sand ranging from 40 to 80%, a part by weight of cement ranging from 20 to 23% and a part by weight of water ranging from 12 to 18%.

Such composition permits production of an element showing high porosity with over 32.5% of void together with perfect cohesion, capable of ensuring excellent heat and sound insulation.

Such a building element can be covered with common coatings to ensure its outer protection against atmospheric attacks.

More specifically, the building element according to a first embodiment is made from a hydraulic mixture with a part by weight of slag in the form of gravel and sand ranging from 53 to 72%, a part by weight of cement ranging from 20 to 22% and a part by weight of water ranging from 12 to 18%.

Preferably, the part of slag gravel and slag sand is distributed as follows:
2-6 mm grain size gravel ranging from 45 to 60%; and
less than 2 mm grain size sand ranging from 8 to 12%.

According to a second embodiment, the building element is made from a hydraulic mixture with a part by weight of slag in the form of gravel and sand ranging from 55 to 65%, a part by weight of cement ranging from 20 to 23% and a part by weight of water ranging from 15 to 18%.

For this second embodiment, the part of slag gravel and slag sand is distributed as follows:
2-6 mm grain size gravel ranging from 35 to 40%; and
less than 2 mm grain size sand ranging from 20 to 25%.

According to another embodiment, the building element is made from a hydraulic mixture to which rubber fragments or rubber balls are added.

According to a first embodiment, the building element 1 consists of a single wall with a rectangular parallelepiped shape. The element according to this embodiment is designed to cover plane faces in conjunction with other elements with the same shape. According to another embodiment, the building element 2 is made of two walls with a rectangular parallelepiped shape, rooted to each other and forming between each other a non-straight angle. In the preferred embodiment, these walls perpendicular to each other form a rectangular dihedral. Element 2 according to this embodiment is designed for angle covering.

The building element can also come in the form of a centered wall.

This element 1, 2 in both its embodiments has a given thickness, length and height, the thickness of this element being relatively small compared to its other two dimensions.

The horizontal lower edge and one of the lateral vertical edges of the building element 1, 2 are each hollowed out with a longitudinal groove 3 and the horizontal upper edge and the other vertical lateral edge of the element each have a longitudinal tenon 4 of a shape complementary to that of the grooves 3.

Using these arrangements, several building elements can be juxtaposed and superposed while being perfectly positioned and secured in relation to one another by engaging tenons 4 of some into the grooves 3 of the others and by resting the lateral edges of some against the lateral edges of the others.

Preferably, the building element is provided with inside vertical re-entrants 5 that run into hollows 6 made in the tenon 4 on the horizontal upper edge. Preferably, those vertical re-entrants 5 are blind. The hollows 6 through their bottom come below the horizontal upper edge of the element.

Preferably, at least two vertical re-entrants 5 apart from each other shall be provided for.

The element 1, 2 can comprise at least one horizontal through-hole 7 made based on its thickness. According to this embodiment, the building element 1, 2 can be without vertical canals. Preferably, two through-holes 7 made based on the same height level will be provided for.

The building element 1, 2 can also have a cellular structure, the cells being formed by vertical through canals.

According to another embodiment of the building element 1, 2, at least one of the faces of said element designed to face the outside, for example the large face(s), is covered with a protective element 11 made out of terracotta or ceramic. Preferably, this protective element shall be produced from a hydraulic mixture with a part by weight ranging from 30 to 70% of less than 2 mm grain size slag sand and clay with a part by weight ranging from 20 to 50%.

This protective element will be affixed on the bottom of the mold used to produce the building element so as to become an integral part of the building element. A sectional view of a building element equipped with a protective element 11 is shown in FIG. 13.

The advantage of such a building element is that it has a wall surface made of terracotta or ceramic, which makes its outside face waterproof.

The building element 1, 2, as described, can be affixed using a high bond mortar onto an already erected sidewall or attached using bracing hooks 13 to a metal frame 14 (FIG. 14) or to a wood frame 15 (FIG. 15) and joined to the adjacent elements with thin cement or glue lines applied on their edges. Each hook will have a tip for fastening to its building element 1 or 2 and a tail to fasten it to the frame. The hook tip will engage into one of the vertical re-entrants 5 of the building element while the hook tail will be attached to the frame using well-known means.

The building element 1, 2 is also designed to produce a lost formwork for producing a vertical supporting sidewall by pouring concrete into the lost formwork and after having poured this supporting sidewall, to constitute a siding element for this wall as well as a heat and sound insulating element of the latter.

Thus, the lost formwork under the invention consists of at least two building elements under the invention, held vertically parallel to each other and apart from each other using cross braces.

According to a first embodiment, the means of bracing consist of cross braces 8, each made of a U-shaped metal rod and having two side wings 81 and a central wing 82. Each rod enters through the two side wings 81 respectively into one of the re-entrants 5 of one of the elements 1 or 2 and into one of the re-entrants 5 of the other element 1 or 2, said re-entrants running into hollows 6. The rods 8 also engage through their central wing into the hollows 6 and bear against the bottom of the latter so as not to create an added thickness on the upper horizontal edge of the elements.

Preferably, each side wing 81 is bent back vertically onto itself to form a U-shaped tie with the free branch extending obliquely to the outside. The width of each side wing 81 measured at the free end of the free branch is slightly greater than the diameter of the re-entrant 6 so that the brace can be inserted by gripping through its wings into the respective re-entrants. In addition, because of its oblique arrangement, the free branch has a natural tendency to punch the inside face of the reentrant, which prevents removal of the brace once put in place.

In addition, according to the preferred embodiment, the central wing 82 of each brace 8 forms a bearing cradle or cavity for the horizontal reinforcement bars inserted between the formwork elements before pouring the concrete.

For a lost formwork made with elements 1 or 2 provided with horizontal through-holes 7, each means of bracing shall consist of a horizontal threaded stud 9 inserted into the through-hole 7 of one of the elements 1, 2 and into the hole 7 facing the other element. This stud receives in the space between the two elements 1, 2, a spacer 10. This spacer 10 is designed to work together with the stud 9 and to bear through its ends against the large vertical faces—inside the formwork—of the two building elements 1, 2. The stud 9 outside the formwork is provided with securing nuts designed to press against the two elements 1, 2.

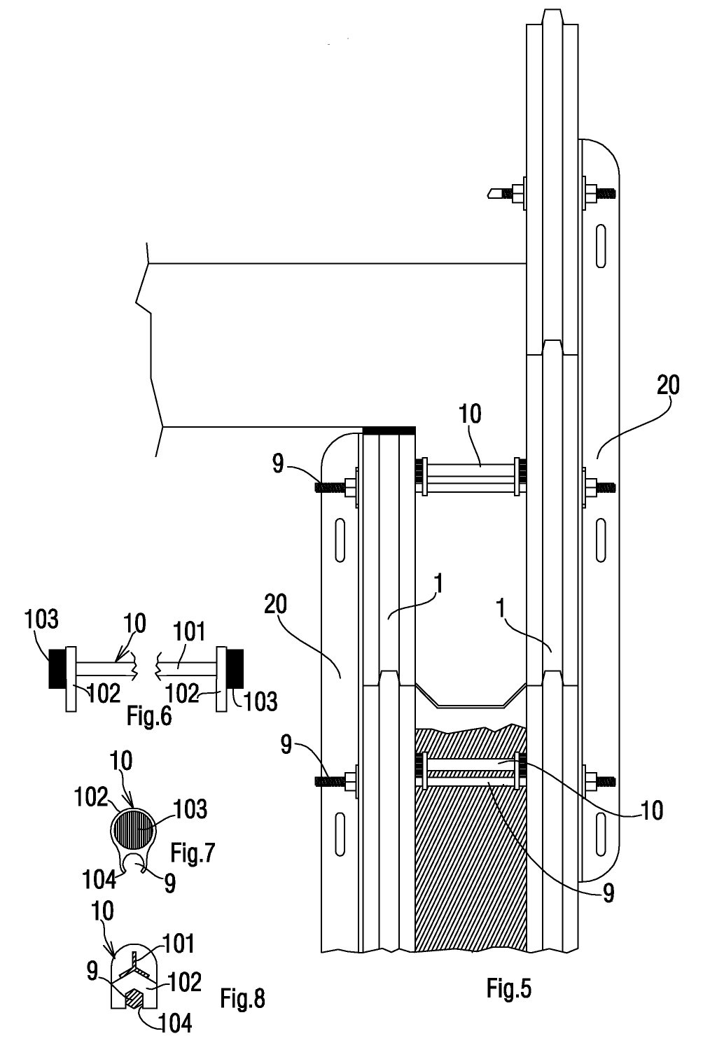

The advantage of using such bracing elements is that they permit to attach to the stud—outside the formwork—vertical rules 20 holding elements 1, 2 that can no longer be braced, for example the elements that make up the lateral formwork of a slab or linteau, as shown in FIG. 5.

According to the preferred embodiment, each spacer 10 consists of a rigid rod 101 featuring at each end two bases 102 in the form of a disk, each bearing a plug 103 made out of a soft material. The spacer 10 is placed between the two end plugs 103 against the two large vertical faces—inside the formwork—of the two building elements 1 or 2. The spacing between the elements 1 or 2 is adjusted by screwing the stud nuts and crushing the plugs 103.

Preferably, each end base 102 of the spacer 10 has a slot 104 through which said spacer is attached to the stud 9. This arrangement allows for a quick and easy installation of the braces 10 between the elements 1 or 2 after having placed the stud in the through-hole.

According to a first alternative embodiment, each stud 9 consists of a cylindrical rod, and the rigid rod 101 of the bracing element is cylindrical (FIGS. 5, 6, 7). According to this alternative embodiment, the slot 104 in each base forms a clamp for adhesion fastening onto the stud 9. According to a second alternative embodiment (FIG. 8), the stud 9 consists of a rod with a hexagonal cross section, threaded at the end and the rigid rod 101 has a three-branch star cross section. The slot 104 in each base has a complementary shape of that of the stud cross section.

These braces will also act as support for the horizontal reinforcing bars inserted into the mold.

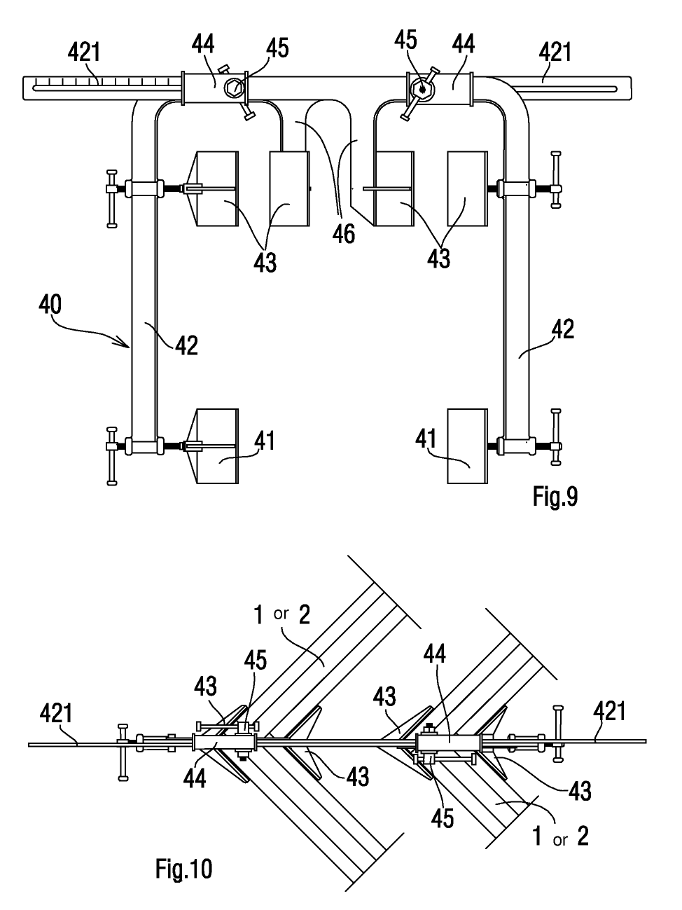

FIGS. 9, 10 and 11 show a means of bracing 40 according to a third embodiment. Contrary to the first and second means, this means of bracing is not intended to remain in the wall to be constructed later by pouring proper concrete into the lost formwork.

This means of bracing 40 permits holding the building elements 1, 2 in position, the elements being cut to height, for which it is not possible or desirable to use the means of bracing according to the first and second embodiments.

This means of bracing comprises two opposite lower clamping jaws 41 borne respectively by two vertical arms 42 whose distance from each other is adjustable, each bearing at the upper end two clamping jaws 43 whose distance from each other is adjustable. Using the lower jaws 41, the means of bracing is clamped against the inner and outer faces of said formwork. The upper jaws 43 borne by one of the arms 42 are clamped onto one of the formwork elements and the upper jaws 43 borne by the other arm are clamped onto the formwork element opposite to the former.

Each arm 42 in its upper part forms a bend and extends horizontally above the jaws to form a horizontal extension 421. This horizontal extension 421 of each arm 42 is designed to slide into a guide sleeve 44 borne by the other arm 42, said guide sleeve 44 being equipped with a screwing device 45 to secure the arm, such as a set screw. One of the upper jaws associated with each arm is borne in a fixed manner by a vertical lug 46 borne by the horizontal extension of each arm, said vertical lug protruding downward. In addition, the height of the upper and lower jaws is adjustable. To that effect, these jaws are each borne by a sleeve sliding onto the arm and provided with a device to secure it in position on the arm, such as set screws.

A vernier will be formed on the horizontal extension 421 of each arm 42 for precision adjustment of the respective positions of the various jaws.

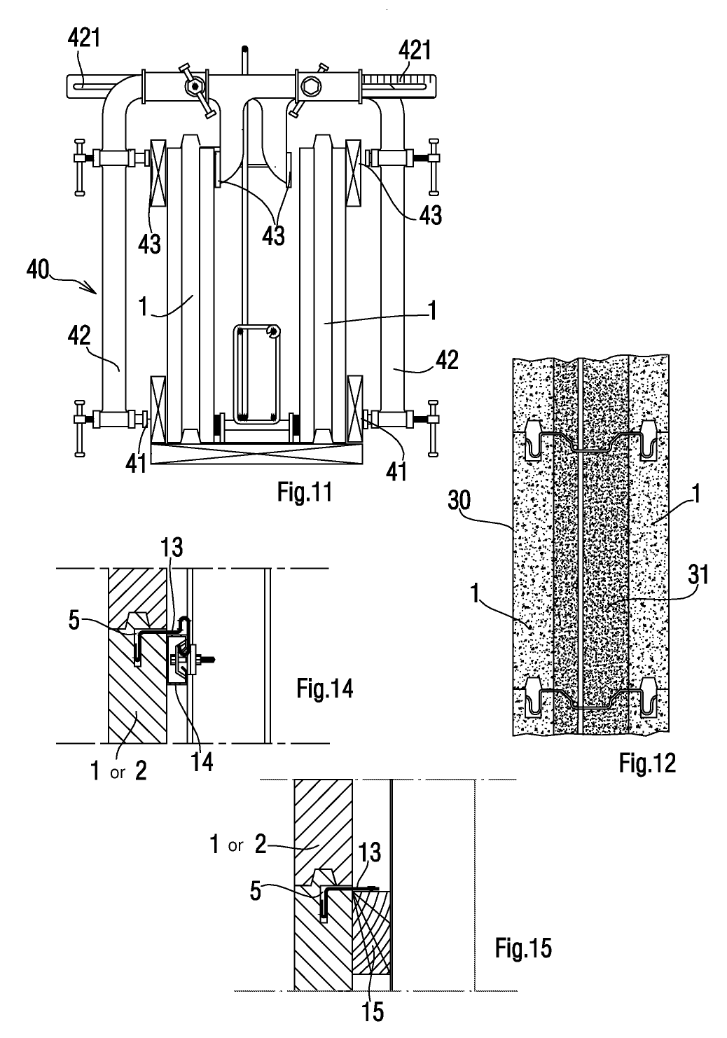

Depending on whether this means is designed to cooperate with angle elements or with facade elements, the jaws will have a dihedral shape, FIGS. 9 and 10 or a flat shape FIG. 11.

The lost formwork, as described, is designed to receive non-porous concrete that after drying will constitute a load-bearing web.

The highly apparent porosity of the building elements and their grainy surfaces promote adhesion of the concrete poured in the formwork.

The choice of thickness for the supporting web will depend on the load to be supported.

The invention concerns also a wall 30 comprising a concrete supporting web 31, in which at least one of the large faces is provided with a facing made of building elements 1 and as previously described. These facing elements 1, 2 that cover the two large faces of the wall, i.e., the building inner face and outer face, give to this wall a high heat and sound insulation capacity because of their high degree of porosity. In addition, because of their constitution, the facing elements provide the wall with a protection against atmospheric attacks and high fire resistance.

Building elements designed for producing lost formwork and facing have previously been described. The building element can also come in the form of a solid or cellular block and can be used to make partition walls.

1. Composition for insulating concrete for producing in particular molded building elements, said composition comprising:
slag being formed of gravel and sand ranging from 40 to 80% by weight;
cement ranging from 20 to 30% by weight; and
water ranging from 10 to 20% by weight for producing concrete.

2. Composition according to claim 1, wherein said slag ranges from 53 to 72%, by weight, said cement ranges from 20 to 22% by weight, and said water ranges from 12 to 18% by weight.

3. Composition according to claim 2, wherein said slag is comprised of
2-6 mm grain size gravel ranging from 45 to 60% by weight; and
less than 2 mm grain size sand ranging from 8 to 12% by weight.

4. Composition according to claim 1, wherein said slag ranges from 55 to 65% by weight, said cement ranging ranges from 20 to 25% by weight, and said water ranges from 15 to 18% by weight.

5. Composition according to claim 4, wherein said slag is comprised of:
2-6 mm grain size gravel ranging from 35 to 40% by weight; and
less than 2 mm grain size sand ranging from 20 to 25% by weight.

6. Composition according to claim 1, further comprising:
rubber fragments or rubber balls.

7. Composition according to claim 6, wherein said rubber fragments or rubber balls have a size ranging from 1 to 6 mm.

8. Building element for producing lost formworks and facing elements, comprising:
a hydraulic mixture being comprised of a part by weight of slag being formed of gravel and sand ranging from 40 to 80% by weight, said cement ranging from 20 to 30% by weight, and water ranging from 10 to 20% by weight.

9. Building element, according to claim 8, wherein said slag ranges from 53 to 72% by weight, said cement ranges from 20 to 22% by weight, and said water ranges from 12 to 18% by weight.

10. Building element claim 9, wherein said slag is comprised of
2-6 mm grain size gravel ranging from 45 to 60% by weight; and
less than 2 mm grain size sand ranging from 8 to 12% by weight.

11. Building element according to claim 8, wherein said slag ranges from 55 to 65% by weight, said cement ranges from 20 to 25% by weight, and said water ranges from 15 to 18% by weight.

12. Building element according to claim 10, wherein said slag is comprised of:
2-6 mm grain size gravel ranging from 35 to 40% by weight; and
less than 2 mm grain size sand ranging from 20 to 25% by weight.

13. Building element according to claim 8, wherein said hydraulic mixture is further comprised of rubber fragments or rubber balls.

14. Building element according to claim 13, wherein said rubber balls have a diameter ranging from 1 to 6 mm.

15. Building element according to claim 8, wherein said hydraulic mixture is shaped into at least one side wall with a rectangular parallelepiped shape.

16. Building element according to claim 15, wherein said hydraulic mixture has a horizontal lower edge and two lateral vertical edges, said horizontal lower edge and one of said two lateral vertical edges being hollowed out with a longitudinal groove, said horizontal upper edge and one other of said two vertical lateral edges each having a longitudinal tenon of a shape complementary to said longitudinal groove.

17. Building element according to claim 15, wherein said hydraulic mixture is shaped into two side walls with a rectangular parallelepiped shape, said two side walls being rooted to each other and forming a non-straight angle therebetween.

18. Building element according to claim 16, further comprising:
inside blind vertical reentrants run into hollows in the tenon on the horizontal upper edge.

19. Building element according to claim 15, further comprising:
at least one through-hole based on thickness.

20. Building element according to claim 15, wherein at least one outside face is covered with a protective element comprised of terracotta or ceramic.

21. Lost formwork comprising:
at least two building elements according to claim 8, the building elements being vertically parallel to each other and being held apart from each other using cross braces.

22. Lost formwork according to claim 21, wherein each building element is comprised of inside vertical reentrants run into hollows made in the tenon on a horizontal upper edge, and bracing means comprised of cross braces, each cross brace being formed by a U-shaped metal rod and having two side wings and a central wing, each cross brace entering, through the two side wings respectively, into one of the reentrants of one of the elements and into one of the reentrants of the other element.

23. Lost formwork according to claim 22, wherein each side wing is vertically bent back onto itself.

24. Lost formwork according to claim 22, wherein said central wing forms a support cradle or cavity for a horizontal reinforcement bar.

25. Lost formwork according to claim 21, wherein each building element comprises at least one through-hole made based on thickness, and means of bracing comprised of a threaded stud inserted into the through-hole of each element and, receiving in space between the two elements, a spacer cooperative with the stud, said spacer bearing ends against the large vertical faces inside the two building elements, said stud outside the two building elements being provided with securing nuts pressed against the elements.

26. Lost formwork according to claim 25, wherein each spacer is comprised of a rigid rod having two bases formed as a disk at each end thereof, each disk bearing a plug comprised of a soft material, said spacer being placed between the two end plugs against the two large vertical faces inside the two building elements.

27. Lost formwork according to claim 26, wherein each base has a slot through which said spacer is attached to the stud.

28. Lost formwork according to claim 21, wherein the means of bracing comprises two opposite lower clamping jaws borne respectively by two vertical arms whose distance from each other is adjustable, each bearing at the upper end two clamping jaws having distance from each other being adjustable, the means of bracing being clamped against the inner and outer faces of said formwork by the lower jaws, the upper jaws borne by one of the arms being clamped onto one of the formwork elements and the upper jaws borne by the other arm being clamped onto the formwork opposite to the former, each arm in an upper part thereof forming a bend and horizontally extending above the jaws, a horizontal extension of each arm sliding into a guide sleeve borne by the other arm, said guide sleeve being equipped with a screwing device to secure the arm, one of the upper jaws associated with each arm being borne in a fixed manner by a vertical lug borne by the horizontal extension of each arm, said vertical lug protruding downward.

29. Wall comprising:
a concrete load-bearing web, the web having at least one face provided with a facing made of a building element, according to claim 8.

30. Wall according to claim 29, wherein the load-bearing web is produced is formed by poured concrete into a lost formwork according to claim 16.
